(19) United States
(12) Patent Application Publication
(10) Pub. No.: US 2026/0076297 A1
(43) Pub. Date: Mar. 19, 2026

(54) DETACHABLE STRING TRIMMER

(71) Applicant: Trimyxs, LLC, Fargo, ND (US)

(72) Inventor: Aaron Halik, Moorhead, MN (US)

(73) Assignee: Trimyxs, LLC, Fargo, ND (US)

(21) Appl. No.: 19/402,662

(22) Filed: Nov. 26, 2025

Related U.S. Application Data
(63) Continuation-in-part of application No. 17/682,344, filed on Feb. 28, 2022, now Pat. No. 12,484,475.
(60) Provisional application No. 63/159,373, filed on Mar. 10, 2021.

(51) Int. Cl. A01D 34/416; A01D 43/16; A01D 101/00

(52) U.S. Cl. CPC A01D 34/416; A01D 43/16; A01D 2101/00

(57) ABSTRACT

A detachable string trimmer assembly for a lawnmower includes a trimmer head; a shaft assembly; a lockable joint attached to the trimmer head and the shaft assembly, the shaft assembly adjustable between a first position at which the trimmer head is coaxial with an axis along the shaft assembly and a second position at which the trimmer head is angled with respect the axis along the shaft; a first mount attached to the shaft assembly to removably attach the detachable string trimmer assembly to the lawnmower; a second mount attached to the shaft assembly to removably attach the detachable string trimmer assembly to the lawnmower; a handle assembly attached to the shaft assembly to selectively operate the trimmer head; and a remote assembly mountable to the lawnmower to selectively operate the trimmer head.

### CROSS REFERENCE TO RELATED APPLICATIONS

This application claims the priority as a continuation-in-part of U.S. Nonprovisional application 17/682,344 (01526-HAL) filed 02/28/2022 which claims benefit to U.S. Provisional Patent Application No. 63/159,373 (01367-HAL) filed 03/10/2021. Each of the aforementioned patent applications, and any applications related thereto, are herein incorporated by reference in their entirety.

### BACKGROUND

The present disclosure relates to a string trimmer for lawn maintenance and more specifically to a detachable string trimmer assembly which is mountable to a lawnmower.

Lawn maintenance often includes mowing grass using a lawnmower as well as trimming grass in areas which may not be fully accessed by the lawnmower. Trimmers are used along fences, around trees, near edging, and many other areas. Typically, weekly lawn care activities consist of two tasks, trimming and mowing. On average, an operator will spend about a minute trimming for every two minutes mowing.

Handheld string trimmers typically have a string like mechanical feature which is quickly rotated to cut weeds and grass. Fine adjustments and not a little dexterity may be needed to position a trimmer such that the weeds and grass is properly cut to a desired length. Although trimming is a meticulous task, it may also pose certain hazards.

### SUMMARY

A detachable string trimmer assembly for a lawnmower according to one disclosed non-limiting embodiment of the present disclosure includes a trimmer head; a shaft assembly; a lockable joint attached to the trimmer head and the shaft assembly, the shaft assembly adjustable between a first position at which the trimmer head is coaxial with an axis along the shaft assembly and a second position at which the trimmer head is angled with respect the axis along the shaft; a first mount attached to the shaft assembly to removably attach the detachable string trimmer assembly to the lawnmower; a second mount attached to the shaft assembly to removably attach the detachable string trimmer assembly to the lawnmower; a handle assembly attached to the shaft assembly to selectively operate the trimmer head; and a remote assembly mountable to the lawnmower to selectively operate the trimmer head.

A further embodiment of any of the foregoing embodiments of the present disclosure includes wherein the handle assembly comprises a battery interface to removably receive a battery.

A further embodiment of any of the foregoing embodiments of the present disclosure includes, wherein the handle assembly comprises a switch to actuate the trimmer head.

A further embodiment of any of the foregoing embodiments of the present disclosure includes wherein the handle assembly at least partially forms the second mount.

A further embodiment of any of the foregoing embodiments of the present disclosure includes wherein the second mount is attachable along an axis of a rear wheel of the lawnmower.

A further embodiment of any of the foregoing embodiments of the present disclosure includes wherein the first mount is attachable along an axis of a front wheel of the lawnmower.

A further embodiment of any of the foregoing embodiments of the present disclosure includes wherein the first mount and the second mount each comprise a magnetic interface.

A further embodiment of any of the foregoing embodiments of the present disclosure includes wherein the remote assembly comprises a battery interface to removably receive a battery.

A further embodiment of any of the foregoing embodiments of the present disclosure includes wherein the remote assembly comprises a switch to actuate the trimmer head.

A further embodiment of any of the foregoing embodiments of the present disclosure includes wherein the remote assembly plugs into the handle assembly.

A further embodiment of any of the foregoing embodiments of the present disclosure includes wherein the switch is remote from the battery.

A method of using a detachable string trimmer assembly according to one disclosed non-limiting embodiment of the present disclosure includes detaching a detachable string trimmer assembly from a lawnmower; removing a battery from a remote assembly mounted to the lawnmower; articulating a trimmer head with respect to a shaft assembly at a lockable joint to a second position, the shaft assembly adjustable between a first position at which the trimmer head is coaxial with an axis along the shaft assembly and the second position at which the trimmer head is angled with respect the axis along the shaft; and installing the battery into a handle assembly of the detachable string trimmer assembly.

A further embodiment of any of the foregoing embodiments of the present disclosure includes wherein the detaching comprises magnetically detaching.

A further embodiment of any of the foregoing embodiments of the present disclosure includes wherein the detachable string trimmer assembly is operable in the first position only while the detachable string trimmer assembly is magnetically attached to the lawnmower.

A further embodiment of any of the foregoing embodiments of the present disclosure includes wherein the detachable string trimmer assembly is operable in the first position in response to activation of a power switch mounted to the lawnmower and in communication with the remote assembly.

A further embodiment of any of the foregoing embodiments of the present disclosure includes wherein the detachable string trimmer assembly is operable in the second position only while the detachable string trimmer assembly is magnetically detached from the lawnmower.

A further embodiment of any of the foregoing embodiments of the present disclosure includes wherein the detachable string trimmer assembly is operable in the second position only in response to a switch on the handle assembly.

A method of using a detachable string trimmer assembly with a lawnmower, according to one disclosed non-limiting embodiment of the present disclosure includes articulating a trimmer head with respect to a shaft assembly at a lockable joint to a first position, the shaft assembly adjustable between the first position at which the trimmer head is coaxial with an axis along the shaft assembly and a second position at which the trimmer head is angled with respect the axis along the shaft; attaching a detachable string trimmer assembly to a lawnmower; and installing a battery to a remote assembly mounted to the lawnmower.

A further embodiment of any of the foregoing embodiments of the present disclosure includes wherein the attaching comprises magnetically attaching.

A further embodiment of any of the foregoing embodiments of the present disclosure includes, wherein the detachable string trimmer assembly is operable in the first position only while the detachable string trimmer assembly is magnetically attached to the lawnmower.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a perspective view of a detachable string trimmer assembly for attachment to a lawnmower according to one disclosed non-limiting embodiment.

FIG. 2 is an exploded view of a trimmer head for the detachable string trimmer assembly.

FIG. 3 is a lower perspective view of the detachable string trimmer assembly in a first position such that the detachable string trimmer assembly may be mounted to lawnmower.

FIG. 4 is a lower perspective view of the detachable string trimmer assembly in a second position such that the detachable string trimmer assembly may be used in the conventional handheld manner.

FIG. 5 is an expanded perspective view of an example lockable joint.

FIG. 6 is an exploded view of a magnetic attachment arrangement for the detachable string trimmer assembly according to one disclosed non-limiting embodiment.

FIG. 7 is a schematic view of a controller for the detachable string trimmer assembly according to one disclosed non-limiting embodiment.

FIG. 8 is an exploded view of a mechanical attachment arrangement for the detachable string trimmer assembly according to one disclosed non-limiting embodiment.

FIG. 9 is an expanded exploded view of a handle assembly for the detachable string trimmer assembly illustrating alternate attachment arrangements.

FIG. 10 is a perspective view of a detachable string trimmer assembly for attachment to a lawnmower according to another disclosed non-limiting embodiment illustrating the remote assembly.

FIG. 11 is an exploded view of a battery tray attachment of the remote assembly.

FIG. 12 is an exploded view of a remote switch of the remote assembly.

### DETAILED DESCRIPTION

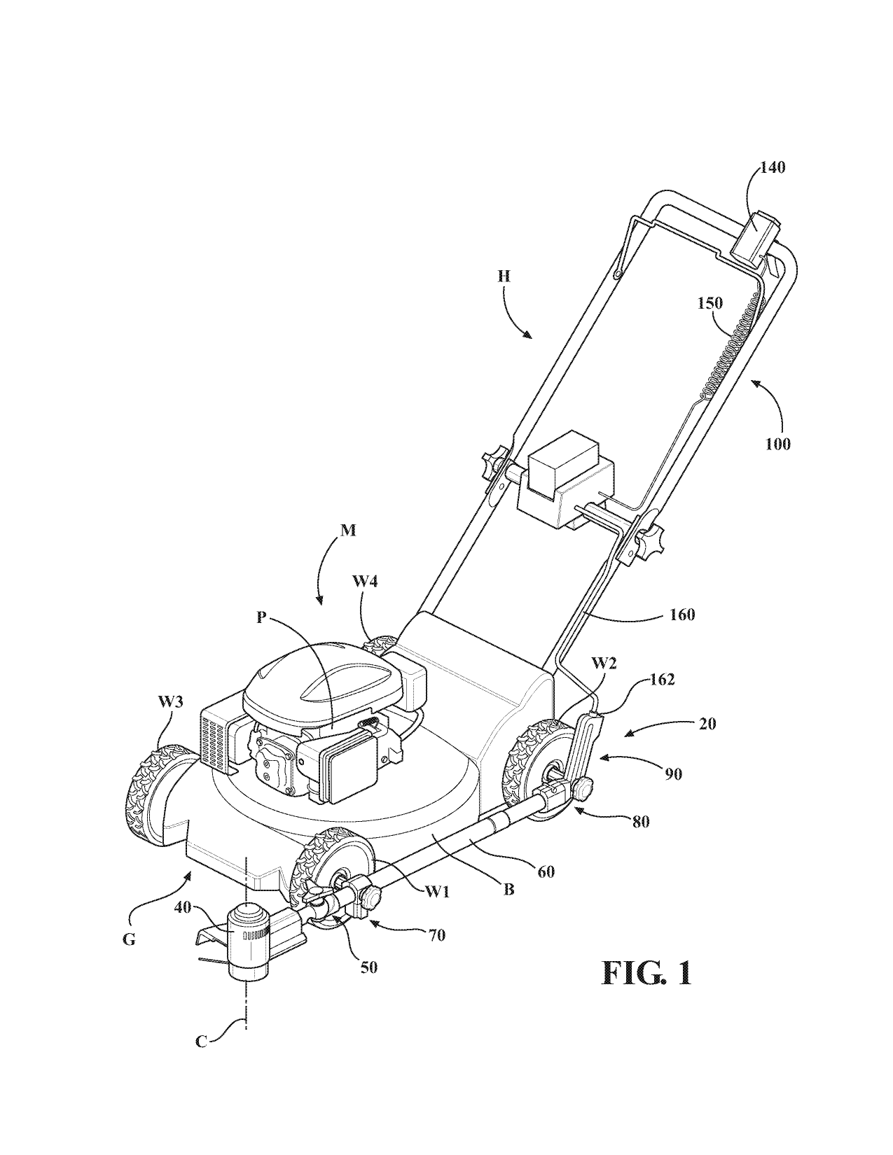

FIG. 1 schematically illustrates a detachable string trimmer assembly 20 for attachment to a lawnmower M. Lawnmower M may be various lawnmowers which typically include a body B, a cutting blade assembly G, a power plant P, a handle assembly H and four wheels W1 – W4. The lawnmower M may be of various configurations such as combustion, electric, power driven, pusher, riding mower, etc.

The detachable string trimmer assembly 20 may be selectively attached to the Lawnmower M for use during cutting operations as disclosed in U.S. Nonprovisional Patent Application No. 17/682,344 (01526-HAL) filed 02/28/2022 which is herein incorporated by reference in its entirety as well as being detachable for use in a conventional handheld manner. Although described with respect to Lawnmower M, the detachable string trimmer assembly 20 disclosed herein may be attached to other parts and/or components of various types of riding lawnmowers, push mowers, and other equipment.

The detachable string trimmer assembly 20 generally includes a trimmer head 40, a lockable joint 50, a shaft assembly 60, a first mount 70, a second mount 80, a handle assembly 90, and a remote assembly 100. Although particular components are identified, the detachable string trimmer assembly 20 may have more, less, or different components than those which are schematically illustrated.

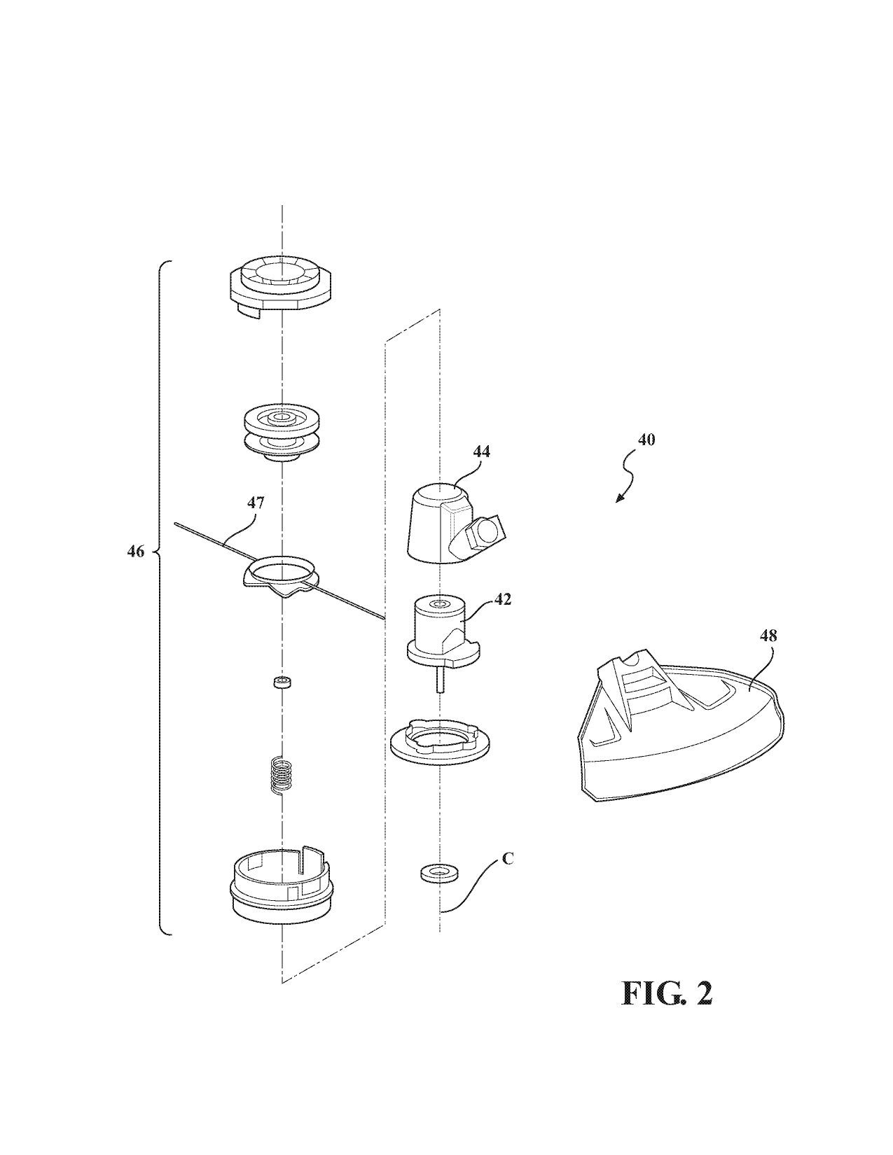

With reference to FIG. 2, in one embodiment, the trimmer head 40 may include a motor 42 secured within a housing 44, a trimmer tool 46, and a trimmer guard 48. The motor 42 drives the trimmer tool 46 from which a cutter 47 extends either directly or through the gear system for rotation about a cutter axis C. Various gear systems and drive arrangements may be provided. The cutter 47 may include a line, blades, or other such device that cuts the grass and weeds as the trimmer tool 46 is rotated about axis C by the motor 42. The trimmer guard 48 shields at least a portion of the cutter 47. The trimmer guard 48 may be a sizable plastic guard that at least partially encircles the cutter 47 to direct the discharge of debris.

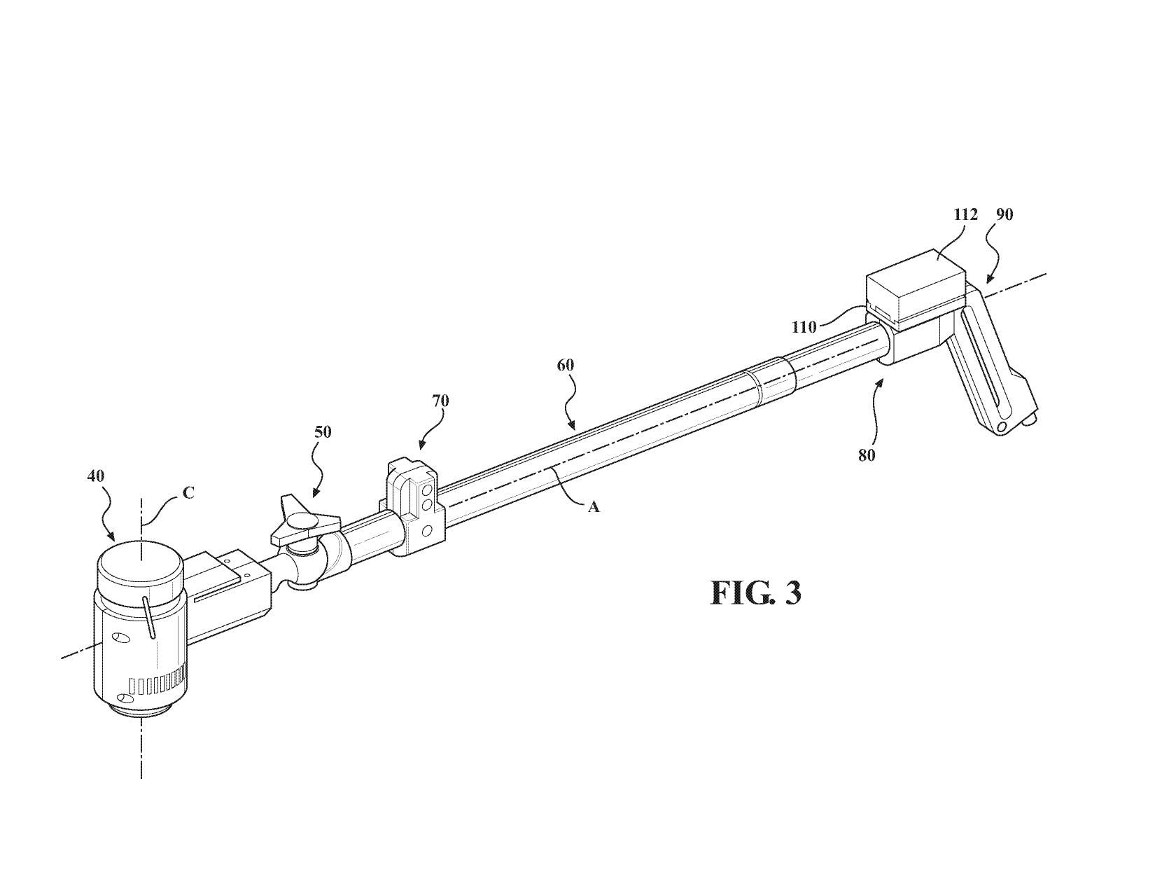

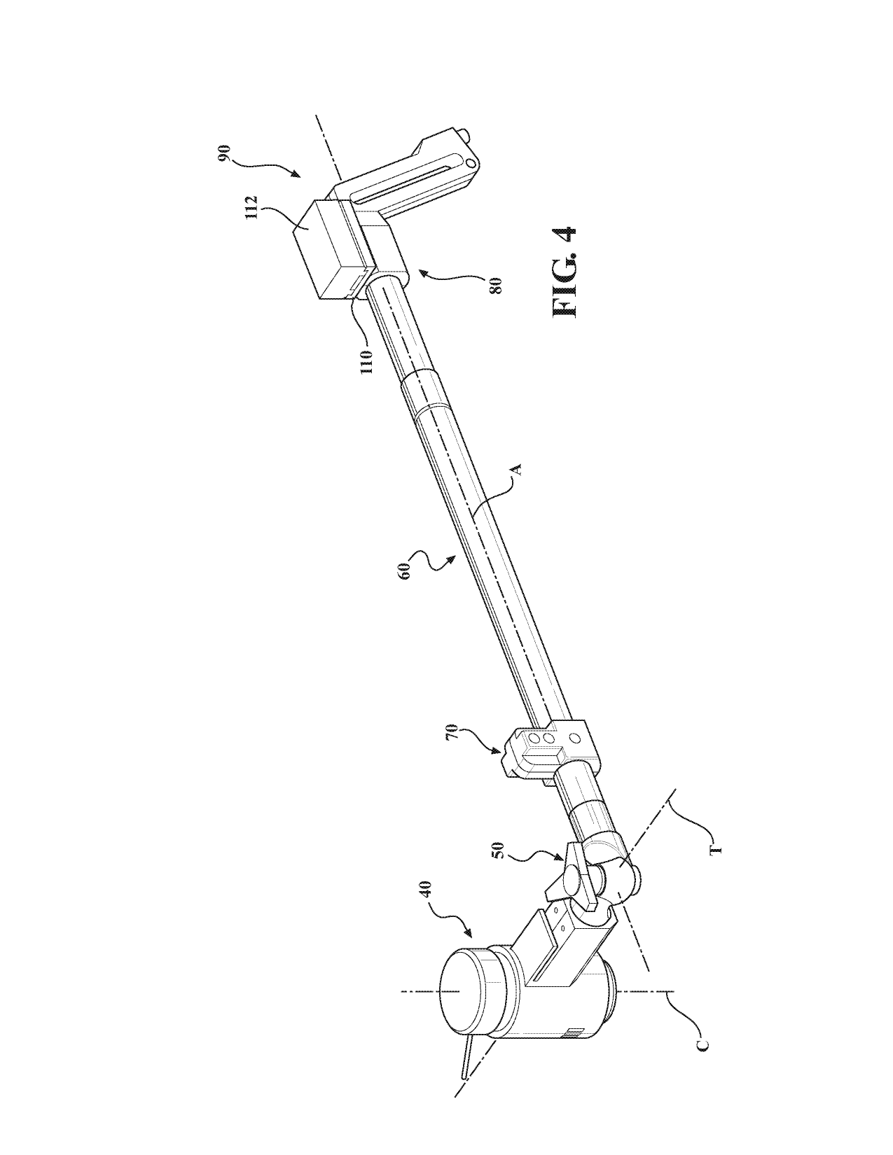

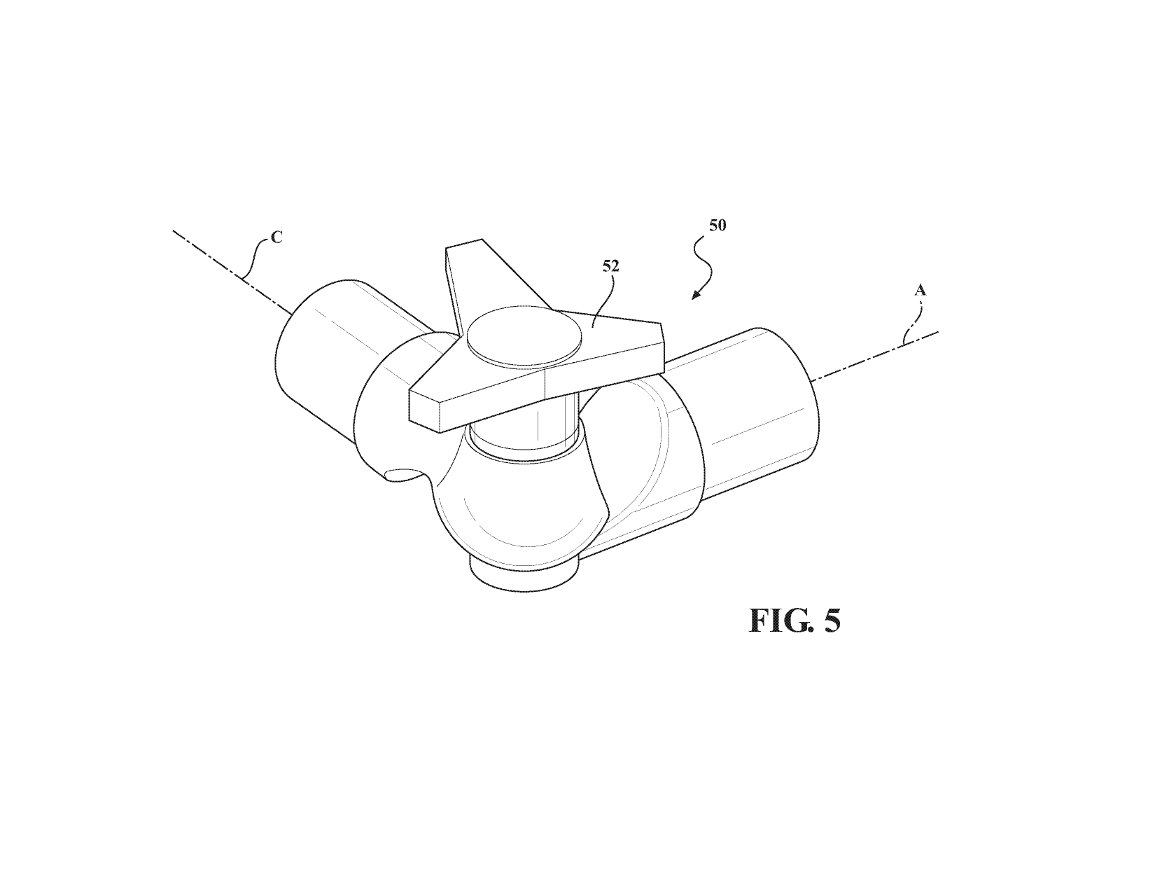

With reference to FIG. 3 - 5, the lockable joint 50 is attached between the trimmer head 40 and the shaft assembly 60 such that the shaft assembly 60 is adjustable between a first position (FIG. 3) at which the trimmer head 40 is coaxial with an axis A along the shaft assembly 60 and a second position (FIG. 4) at which the trimmer head 40 defines an axis T that is angled with respect the axis A. The lockable joint 50 (FIG. 5) may permit various positions of the trimmer head 40 with respect to the shaft assembly 60 such that the detachable string trimmer assembly 20 may be used in the conventional handheld manner. The lockable joint 50 may also permit rotation about the axis A such that, for example, as both a trimmer and an edger in both the attached and detached position. In one example, the lockable joint 50 may provide a range of movement from -105° to 105° and is selectively locked by a knob 52.

The first mount 70, the second mount 80 and the handle assembly 90 may be mounted to the shaft assembly 60. The shaft assembly 60 may include other features such as secondary handles, etc., to facilitate use in the conventional handheld manner.

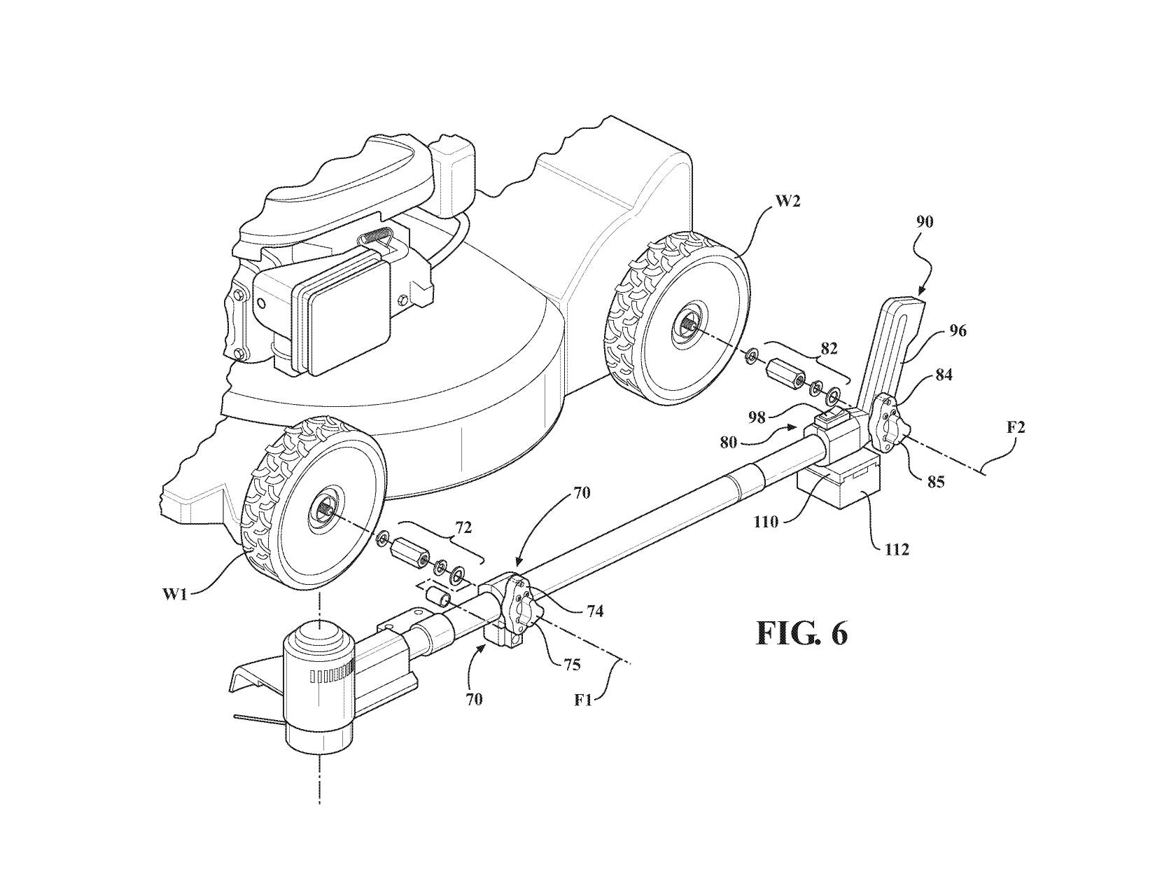

With reference to FIG. 6, the first mount 70 and the second mount 80 are respectively magnetically attachable along an axis F1 of the front wheel W1 and an axis F2 of the rear wheel W2. An attachment coupler 72, 82 may be respectively affixed along the axis F1 of the front wheel W1 and the axis F2 of rear wheel W2 such that the first mount 70 and the second mount 80 are magnetically engageable therewith via a magnetic interface 74, 84.

The attachment coupler 72, 82 provides a rotationally fixed mounting surface to receive the first mount 70 and the second mount 80. That is, the attachment coupler 72, 82 is mechanically fastened along the axis F1 of the front wheel W1 and the axis F2 of rear wheel W2 but does not rotate with the respective wheel W1, W2. Bearings, bushings, and or other such components may be additionally or alternatively provided.

The first mount 70 and the second mount 80 may include a respective magnetic interface 74, 84, for example, a MagJig manufactured by Magswitch of Superior, Colorado, that may be magnetically fastened to the attachment coupler 72, 82. The magnetic interfaces 74, 84, may permit the magnetic field to be turned completely on and off mechanically with a knob 75, 85, to facilitate attachment and removal of the detachable string trimmer assembly 20. The first mount 70 and the second mount 80 may each include a limit switch 76, 86 to magnetically, electrically, and/or mechanically sense whether the first mount 70 and/or the second mount 80 detach from the attachment coupler 72, 82.

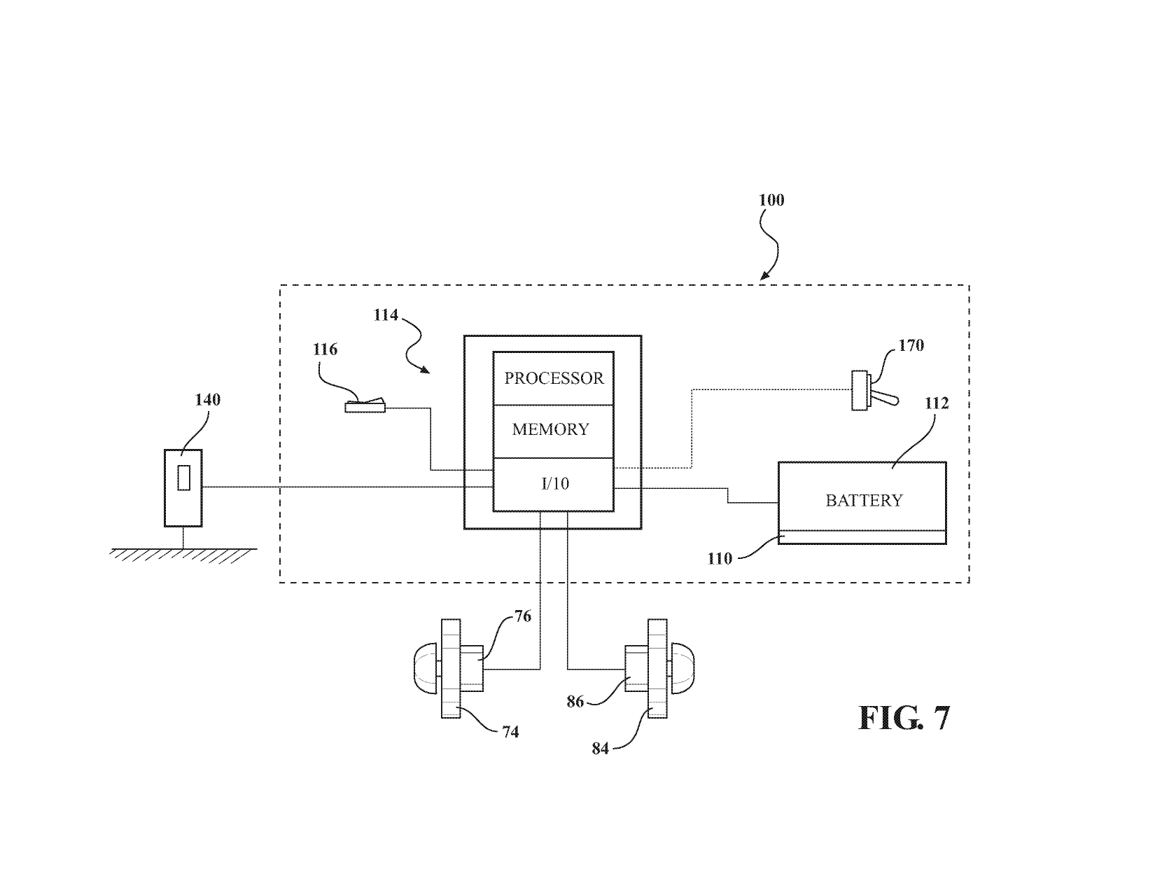

In one embodiment, the second mount 80 may be incorporated into the handle assembly 90. The handle assembly 90 may include a battery mount 110 to receive a battery 112, a controller 114, and an on/off switch 116 (FIG. 7). The controller 114 may include at least one processor, e.g., microprocessor, microcontroller, digital signal processor, etc., a memory, and an input/output (“I/O”) interface. The processor and the I/O interface are communicatively coupled to the memory. The memory may be embodied as various forms of ROM, RAM, which stores data and control algorithms such as the logic described herein to control, for example, the motor 42 in the trimmer head 40. The I/O interface is communicatively coupled to a number of hardware, firmware, and/or software components, including, for example, the motor 42 via the on/off switch 116 and the limit switches 76, 86 to, for example, shut down the trimmer head 40 in response to detachment of the first mount 70 and/or the second mount 80 from the attachment coupler 72, 82.

The on/off switch 116 may be located adjacent to the shaft assembly 60 and the handle portion 96. The on/off switch 116 may be a trigger protected by a guard 98. Additional safety switches may be provided which need also be activated in conjunction with the on/off switch 116 to activate the trimmer head 40.

As the detachable string trimmer assembly 20 is mounted with the magnetic interfaces 74, 84, once an external force exceeds the magnetic force that retains the detachable string trimmer assembly 20 to the lawnmower M, the detachable string trimmer assembly 20 will "break away" from the lawnmower M and either or both of the limit switches 76, 86 will be activated to shut down the trimmer head 40. That is, should the detachable string trimmer assembly 20 be detached from the lawnmower M, the detachable string trimmer assembly 20 will be deactivated irrespective of the on/off switch 116 position. An example of this would be if a user accidentally hit a tree with the detachable string trimmer assembly 20. Either or both of the magnetic interfaces 74, 84, would be overcome by the impact and the detachable string trimmer assembly 20 would separate from the lawnmower M. This breakaway feature assures that the user, the detachable string trimmer assembly 20 and the lawnmower M remain safe from damage should the trimmer head 40 be operable during detachment.

In one example, the breakaway force (L) as measured by a GOYOJO 500N Digital Force Gauge applied to the trimmer head 40 may be: Normal Up 40-60N; Normal Down 110-210N; Shear Left 20-30N; and Shear Right 20-30N.

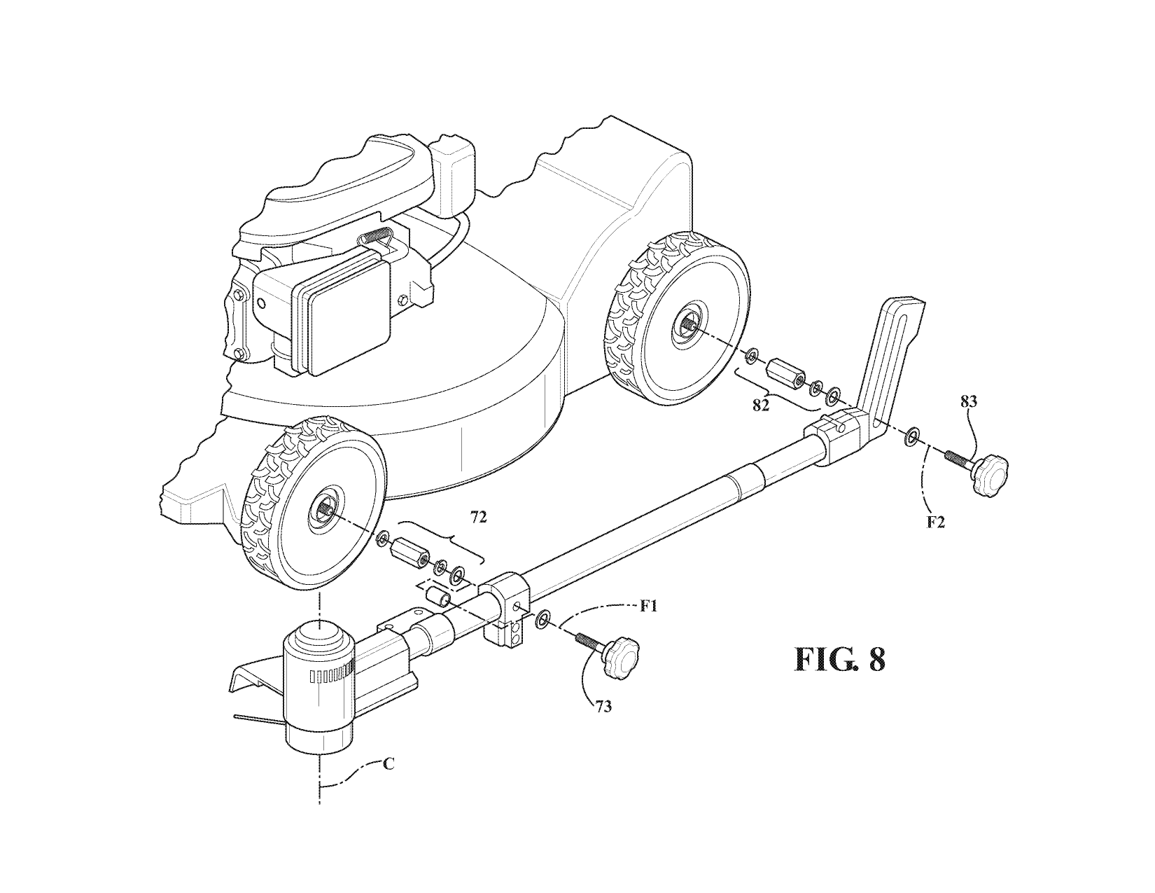

With reference to FIG. 8, in another embodiment, the attachment coupler 72, 82 may be a mechanical arrangement which utilizes a threaded knob 73, 83 along axis F1, F2 or other threaded coupler to removably mount the detachable string trimmer assembly 20. That is, the detachable string trimmer assembly 20 is fastened via threaded components which may be hand tightened and loosened which foregoes the breakaway feature.

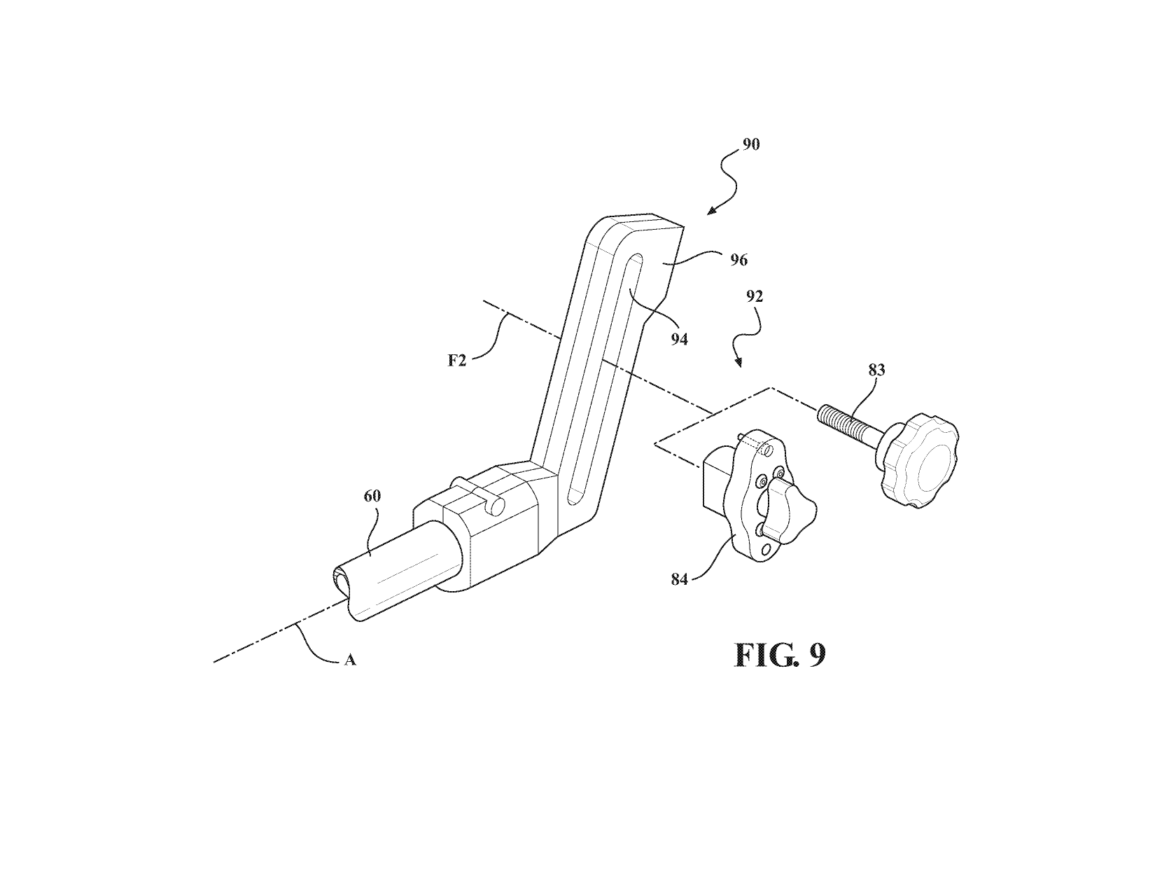

With reference to FIG. 9, in other embodiments, the handle assembly 90 may include an adjustment 92 such as a slot 94 through which the magnetic interface 84 or threaded knob 83 is mounted. The slot 94 may extend along the handle portion 96 which is transverse to the shaft assembly 60. In this embodiment, the magnetic interfaces 84 may be positioned and secured within the slot 94 such that the trimmer head 40 pivots around the axis F1 of the front wheel W1. This pivot effectively causes the trimmer head 40 to angularly raise or lower in relation to the ground surface to provide adjustment.

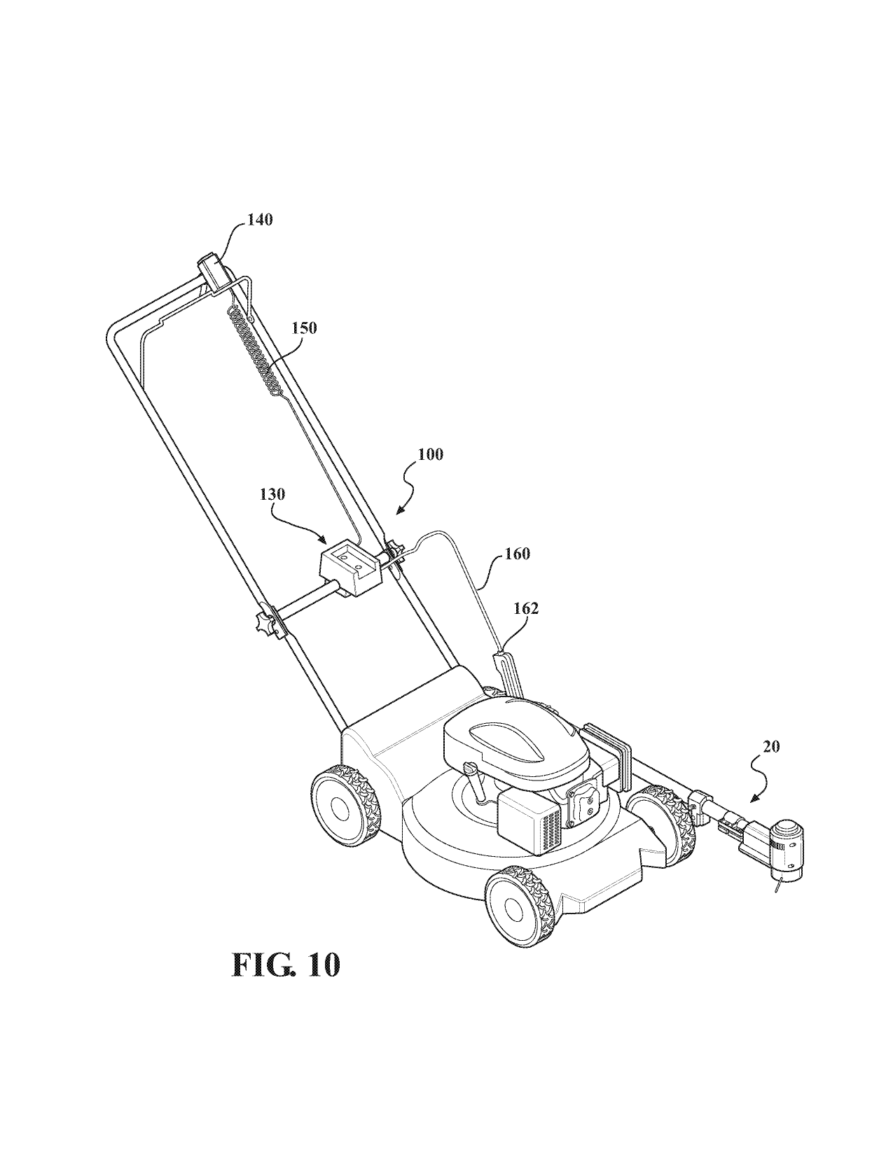

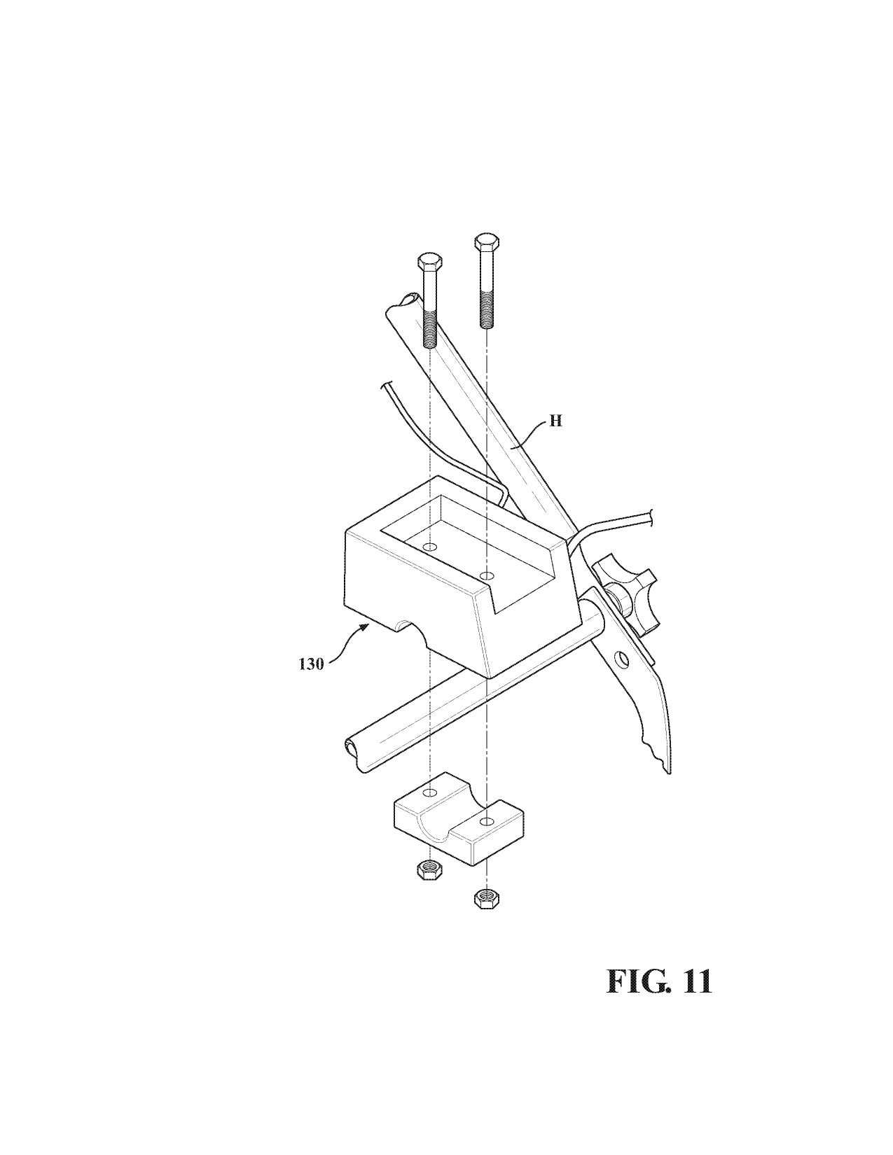

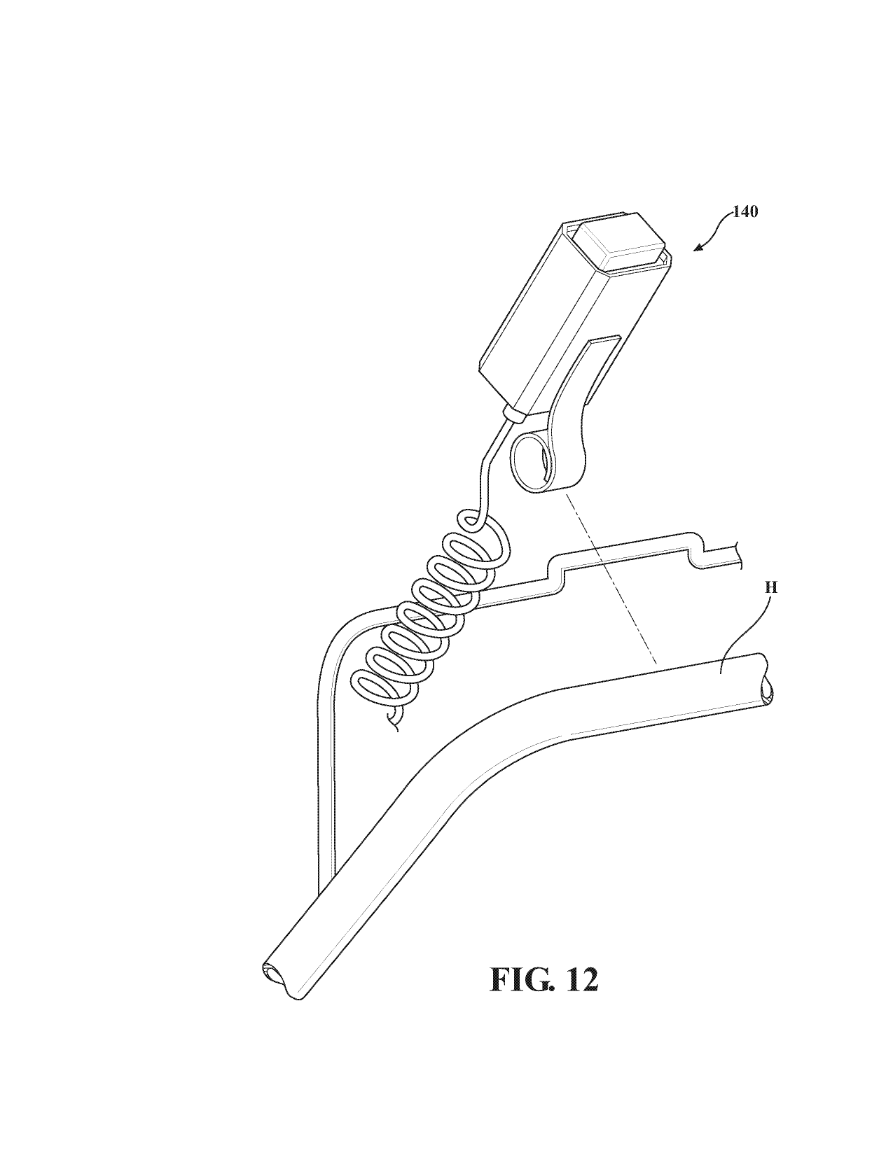

With reference to FIG. 10, in other embodiments, the remote assembly 100 may include a battery mount 130 (FIG. 11) and a remote switch 140 (FIG. 12) that are in communication with the controller 114. The battery 112 may be the same as that which is receivable in the battery mount 110. The battery 112 is thereby readily accessible yet protected from the lawnmower operation.

The remote switch 140 may be connected to the battery mount 130 via a cable 150 and the battery mount 130 may be connected to the controller 114 (FIG. 7) via a cable 160 that plugs into a port 162 in the handle assembly 90. Alternatively, various connections including wireless, Bluetooth, and other communication protocols may be utilized.

In response to the cable 160 being plugged into the port 162 in the handle assembly 90 the controller 114 overrides operation of the on/off switch 116 and instead receives commands from the remote switch 140. Alternatively, a switch 170 (FIG. 7) may be located on the handle assembly 90 to switch between the on/off switch 116 and the remote switch 140 connected to the port 162.

The detachable string trimmer assembly 20 is inherently safe via at least the sizable plastic guard encircling the cutter to prevent the discharge of debris; the ability to shear at the magnetic interface at which time power is disengaged; and the significant displacement of the operator from the trimmer head. These safety features work in unison to ensure that the detachable string trimmer assembly 20 will not be damaged if an obstacle is struck and that the trimmer will not continue running in case of disengagement.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason, the appended claims should be studied to determine true scope and content.

What is claimed:

1. A detachable string trimmer assembly for a lawnmower, comprising:
a trimmer head;
a shaft assembly;
a lockable joint attached to the trimmer head and the shaft assembly, the shaft assembly adjustable between a first position at which the trimmer head is coaxial with an axis along the shaft assembly and a second position at which the trimmer head is angled with respect the axis along the shaft;
a first mount attached to the shaft assembly to removably attach the detachable string trimmer assembly to the lawnmower;
a second mount attached to the shaft assembly to removably attach the detachable string trimmer assembly to the lawnmower;
a handle assembly attached to the shaft assembly to selectively operate the trimmer head; and
a remote assembly mountable to the lawnmower to selectively operate the trimmer head.

2. The assembly as recited in claim 1, wherein the handle assembly comprises a battery interface to removably receive a battery.

3. The assembly as recited in claim 2, wherein the handle assembly comprises a switch to actuate the trimmer head.

4. The assembly as recited in claim 3, wherein the handle assembly at least partially forms the second mount.

5. The assembly as recited in claim 4, wherein the second mount is attachable along an axis of a rear wheel of the lawnmower.

6. The assembly as recited in claim 5, wherein the first mount is attachable along an axis of a front wheel of the lawnmower.

7. The assembly as recited in claim 6, wherein the first mount and the second mount each comprise a magnetic interface.

8. The assembly as recited in claim 1, wherein the remote assembly comprises a battery interface to removably receive a battery.

9. The assembly as recited in claim 8, wherein the remote assembly comprises a switch to actuate the trimmer head.

10. The assembly as recited in claim 9, wherein the remote assembly plugs into the handle assembly.

11. The assembly as recited in claim 10, wherein the switch is remote from the battery.

12. A method of using a detachable string trimmer assembly, comprising:
detaching a detachable string trimmer assembly from a lawnmower;
removing a battery from a remote assembly mounted to the lawnmower;
articulating a trimmer head with respect to a shaft assembly at a lockable joint to a second position, the shaft assembly adjustable between a first position at which the trimmer head is coaxial with an axis along the shaft assembly and the second position at which the trimmer head is angled with respect the axis along the shaft; and
installing the battery into a handle assembly of the detachable string trimmer assembly.

13. The method as recited in claim 12, wherein the detaching comprises magnetically detaching.

14. The method as recited in claim 13, wherein the detachable string trimmer assembly is operable in the first position only while the detachable string trimmer assembly is magnetically attached to the lawnmower.

15. The method as recited in claim 14, wherein the detachable string trimmer assembly is operable in the first position in response to activation of a power switch mounted to the lawnmower and in communication with the remote assembly.

16. The method as recited in claim 13, wherein the detachable string trimmer assembly is operable in the second position only while the detachable string trimmer assembly is magnetically detached from the lawnmower.

17. The method as recited in claim 13, wherein the detachable string trimmer assembly is operable in the second position only in response to a switch on the handle assembly.

18. A method of using a detachable string trimmer assembly with a lawnmower, comprising:
articulating a trimmer head with respect to a shaft assembly at a lockable joint to a first position, the shaft assembly adjustable between the first position at which the trimmer head is coaxial with an axis along the shaft assembly and a second position at which the trimmer head is angled with respect the axis along the shaft;
attaching a detachable string trimmer assembly to a lawnmower; and
installing a battery to a remote assembly mounted to the lawnmower.

19. The method as recited in claim 18, wherein the attaching comprises magnetically attaching.

20. The method as recited in claim 19, wherein the detachable string trimmer assembly is operable in the first position only while the detachable string trimmer assembly is magnetically attached to the lawnmower.
